(19) United States
(12) Patent Application Publication
(10) Pub. No.: US 2015/0120352 A1
(43) Pub. Date: Apr. 30, 2015

(54) Real Estate Information Management

(71) Applicant: Matt Steel, Bellevue, WA (US)

(72) Inventor: Matt Steel, Bellevue, WA (US)

(21) Appl. No.: 14/523,838

(22) Filed: Oct. 24, 2014

Related U.S. Application Data
(60) Provisional application No. 61/894,969, filed on Oct. 24, 2013.

(51) Int. Cl. G06Q 30/02; G06Q 50/16; G06Q 10/06

(52) U.S. Cl. CPC G06Q 30/0278; G06Q 10/063112; G06Q 50/16
USPC 705/7.14; 705/306

(57) ABSTRACT

Techniques and technologies related to real estate information management are described. Real estate information management may allow a user to obtain information about a property, including potential return on investment, an estimated rental price, or an estimate value for purchasing the property. A user may also obtain a referral to an agent based on the agent's experience.

### FIELD

This disclosure generally relates to real estate information management.

### BACKGROUND

Evaluating real estate may be done using a variety of techniques. Appraisers or others tasked to determine a fair market value of a residence will often analyze particular features of residence being evaluated and compare it to other houses sold recently in similar locations. Various techniques may provide one or more numbers representing a range of values for the target property.

### SUMMARY

The instant application generally discloses, among other things, techniques and technologies to assist in valuing a property, and to provide information as to predicted returns on investment (ROIs) for the property and possible modifications to the property. It also discloses technology to assist real estate agents and clients to contact and engage with one another.

In one embodiment, an owner may add or edit information about a house, including modifications such as a remodel, or to correct information, for example if there is an incorrect number of bedrooms listed.

In another embodiment, an analysis may be made for investment potential, including, for example, whether a bathroom or kitchen remodel would provide an acceptable ROI.

Searching may be provided by ROI, equity, cash flow, or other information.

Buyers may obtain information about a property, as well as information about a real estate agent, and may share information about properties or real estate agents with other buyers.

Real estate agents may obtain information about potential clients interested in a property, for example, which people have been in a house, and may share information about properties with potential clients or other real estate agents.

Other features, objects, and advantages of this disclosure will become apparent from the following description, taken in connection with the accompanying drawing, wherein, by way of illustration, example embodiments of the invention are disclosed.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram illustrating an example of a system capable of supporting Real Estate Information Management according to one embodiment.

FIG. 2 is a block diagram illustrating interactions in Real Estate Information Management according to one embodiment.

FIG. 3 illustrates one way to find information about a Property of Interest 310 according to one embodiment.

FIG. 4 is a flow diagram illustrating determining an ROI prediction using Real Estate Information Management according to one embodiment.

FIG. 5 is a flow diagram illustrating determining a rental value using Real Estate Information Management according to one embodiment.

FIG. 6 is a flow diagram illustrating determining a purchase value using Real Estate Information Management according to one embodiment.

FIG. 7 is a flow diagram illustrating example techniques for rating an agent for a referral, according to one embodiment.

FIG. 8 is a block diagram illustrating an example computer according to one embodiment.

### DETAILED DESCRIPTION

In the following detailed description, reference is made to the accompanying drawings, which form a part hereof. In the drawings, similar symbols typically identify similar components, unless a context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure is generally drawn, among other things, to technologies relating to Real Estate Information Management. In some examples, users may post and access Real Estate Information Management content about specific locations in a specific time-frame using mobile computing devices, wherein the Real Estate Information Management content may include information and location data. Other data may include audio, text, and images.

Content, including audio, text, video, images, and time data, may be posted and accessed about specific real estate using mobile computing devices.

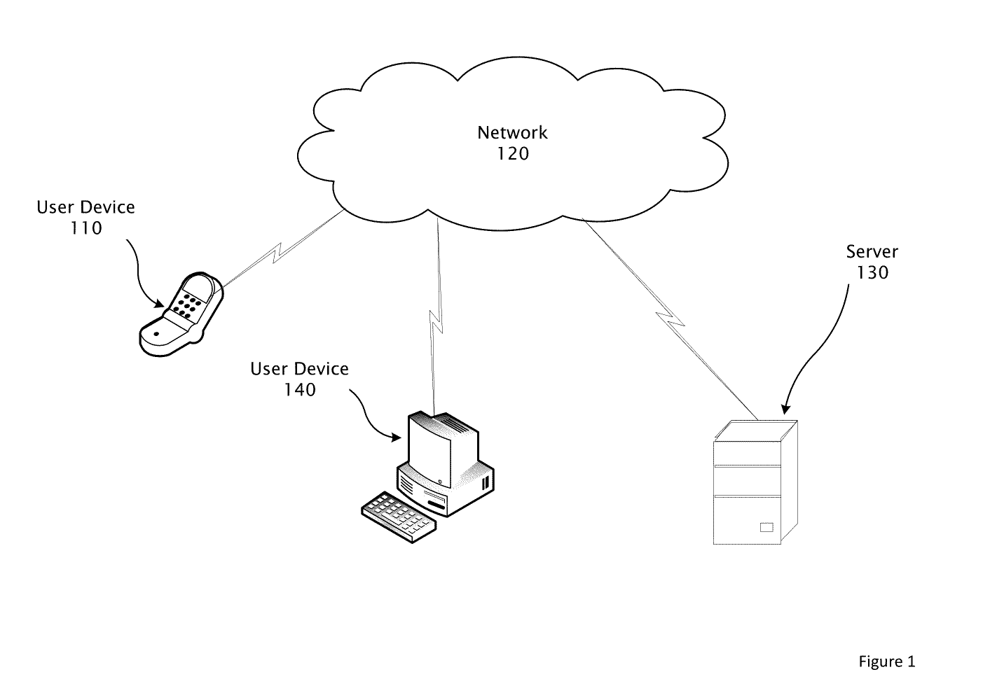

FIG. 1 is a block diagram illustrating an example of a system capable of supporting Real Estate Information Management according to one embodiment.

Network 120 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 120 may comprise Ethernet connectivity. In another embodiment, Network 120 may comprise fiber optic connections.

User Device 110, 140 may be a smartphone, tablet, laptop computer, or other device with location-based services, for example GPS, cellphone tower triangulation capability, or accelerometers, and may have network capabilities to communicate with Server 130. User Device 110, 140 may also be based upon organic computing, or other technologies being developed.

User Device 110, 140 may also be a mobile device or a desktop computer, server, or other computing device.

Server 130 may include one or more computers, and may serve several roles. Server 130 may be conventionally constructed, or may be of a special purpose design for processing data relating to Real Estate Information Management. One skilled in the art will recognize that Server 130 may be of many different designs and may have different capabilities.

In one embodiment, User Device 110 may be used by a client, for example a potential buyer, to find or share information about a property. The property may be identified by Proximity 320 to User Device 110, 140, using location-based services such as a GPS, by entering an address, by doing an image search with a picture of the property, or by performing a search for properties for sale. Such a search may be based on location identifiers, such as school zone, zip code, city, or neighborhood, for example, or by a price range or a predicted return on investment (ROI), particular specifications, such as number of bedrooms or overall square footage, or a combination of two or more of such attributes. One having skill in the art will recognize that many different search criteria may be used to obtain a list of properties of interest.

Searches may be performed via an application on a mobile device, an application on a personal computer, or on a website. One having skill in the art will recognize that many techniques and technologies may be used to provide search capability.

In another embodiment, Real Estate Information Management may allow clients to find and share information about real estate agents, for example sharing experiences in dealing with an agent when buying or selling a home.

In another embodiment, User Device 110, 140 may be used by real estate agents to find or share information about a property. Property information available to clients may be available to real estate agents, as well as additional information shared only with other real estate agents.

One having skill in the art will recognize that any information related to property, areas, or people involved with the real estate industry may be found and shared using Real Estate Information Management.

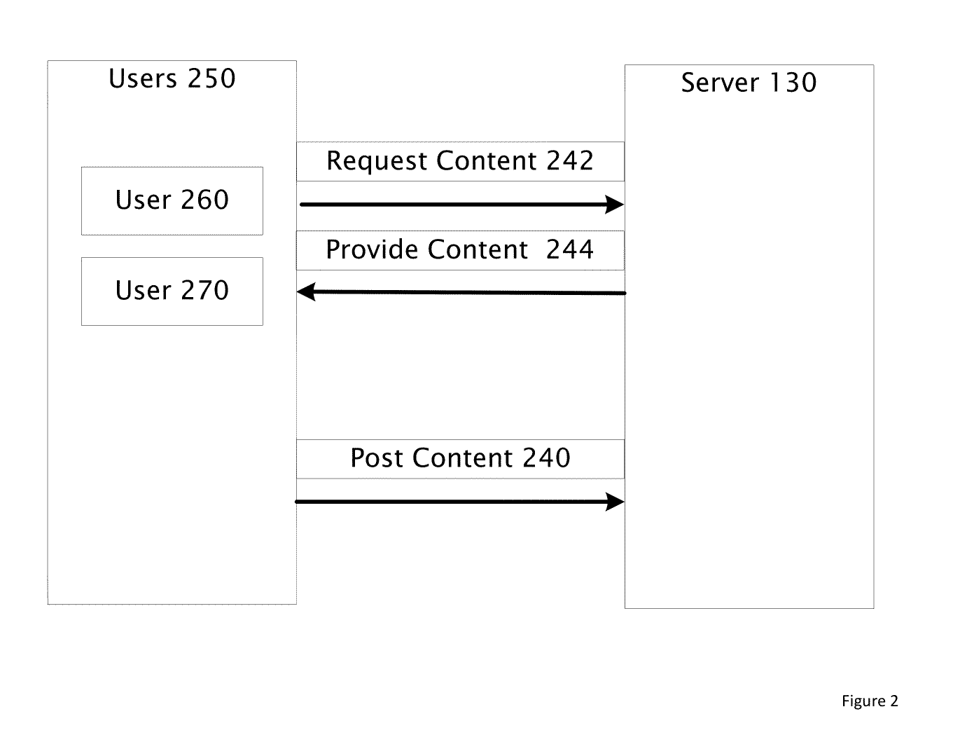

FIG. 2 is a block diagram illustrating interactions in a Real Estate Information Management according to one embodiment. Users 250 may be clients or real estate agents. Using a User Device 140, a real estate agent User 270 may enter information Post Content 240 about a Property of Interest 310, and make it available to clients via Server 130. A client User 260 may then use User Device 110 to Request Content 242, and receive the information Provide Content 244 the real estate agent entered from Server 130.

User 260 may also post comments or other information about Property of Interest 310. Comments entered by User 260 may be kept private by User 260, may be shared with other users through Real Estate Information Management or social networking services, or may be made public. User 260 may also mark one or more properties as favorites, or save a list of one or more properties to create a property tour plan. A property tour plan may determine a suitable route to visit the properties on the list, and may send the route to User 260's email or an agent whom User 260 is working with. One skilled in the art will recognize that various ways may be used to communicate potential routes to one or more interested people.

Real Estate Information Management may track activity by users, and may share that data with real estate agents. Summary reports may be available showing overall interest in a property, school district, or other demographic filters.

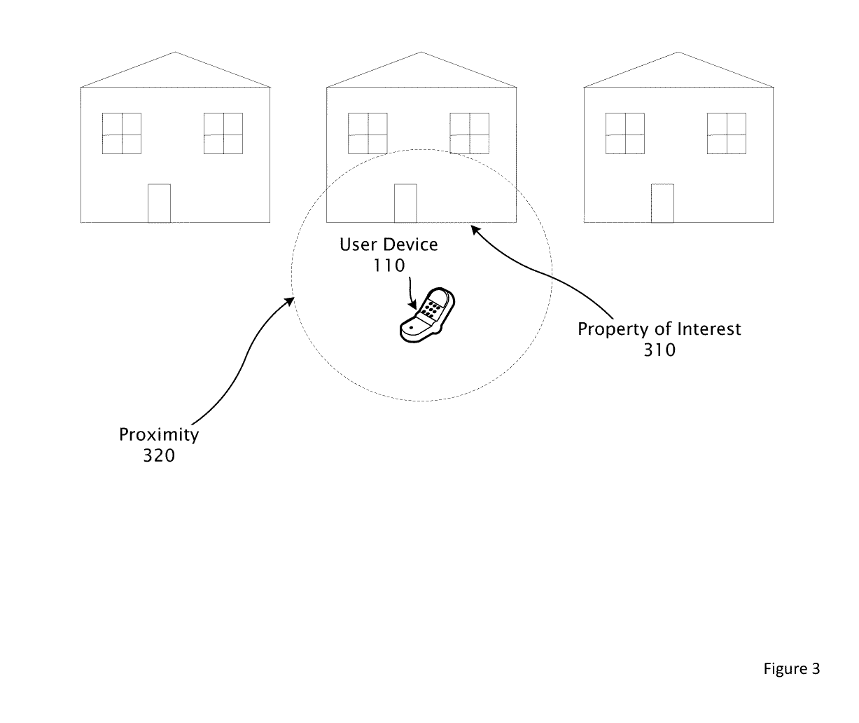

FIG. 3 illustrates one way to find information about a Property of Interest 310 according to one embodiment. While visiting houses for sale, a User 260 may stop in front of a Property of Interest 310. Real Estate Information Management may determine that Property of Interest 310 is within Proximity 320 of User Device 110, and may provide information about Property of Interest 310. Location-based services on User Device 110 may be matched with a known location of Property of Interest 310 to assist in that determination. Location-based services may include GPS, cellphone tower triangulation, having a device on or near Property of Interest 310 with which User Device 110 may communicate, having a user enter location information, or any other means of determining a location for User Device 110.

In another embodiment, User 260 may also identify Property of Interest 310 by entering an address or a Multiple Listing Service (MLS) number. In yet another embodiment, a User 260 may identify a property by taking a picture and submitting the picture to an image search service.

When Property of Interest 310 is identified, information may be delivered to User 260, which may include any available public data, listing brokers, contact information for one or more agents, and additional information that may be entered by owners, agents, brokers, or others. Public data may include tax history, prior sales, school districts, owners, assessment information, improvements, and other data.

One having skill in the art will recognize that many different types of information may be delivered to a user, and that such information may come from many sources.

While near a Property of Interest 310, User 260 may have an option to contact a listing agent, contact nearby agents, contact agents who have viewed the property, contact agents who have properties listed nearby, contact an agent they have been working with, or find and contact agents based on other factors.

In another embodiment, User 260 may be matched with an agent by an administrator of Real Estate Information Management.

When User 260 contacts an agent using Real Estate Information Management, communications may be tracked.

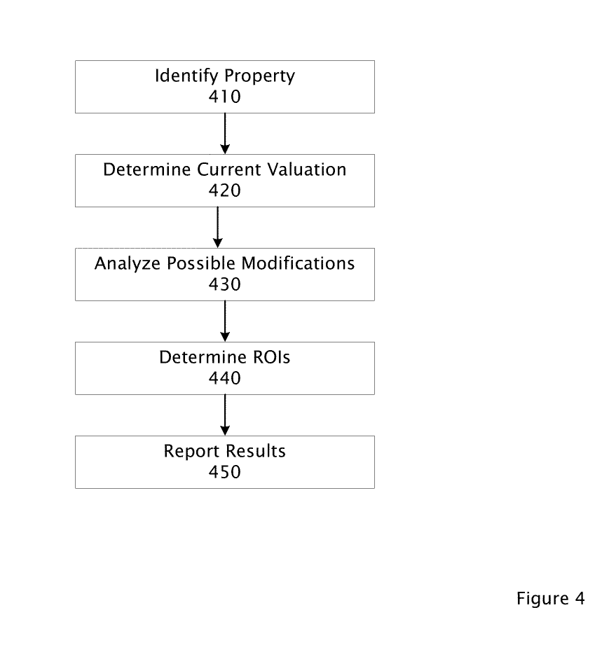

FIG. 4 is a flow diagram illustrating determining an ROI prediction using Real Estate Information Management according to one embodiment. A Property may be Identified 410 using a number of techniques, such as by Proximity 320 to User Device 110, 140, by using location-based services such as a GPS, by entering an address, by doing an image search with a picture of the property, or by performing a search for properties for sale. One having skill in the art will recognize that many different approaches to identifying a property may be used.

A Current Valuation may then be Determined 420, incorporating information from one or more sources such as tax records, comparable sales, history of sales of the property, appraisals, and offers to purchase. One skilled in the art will recognize that many ways of evaluating a property may be implemented. In one embodiment, Identified User Property 410 may be used to define a neighborhood, a one-half to one-mile radius, a zip code, and a city. Real Estate Information Management uses Network 120 to contact Servers 130 to search for data concerning active pending and sold properties, a number of days properties took to go pending on average, the number of new active properties, and the total active and sold properties. One having skill in the art will recognize there are many different ways to obtain the listed data via Servers 130. A market exsorption rate may then be determined for the neighborhood, one-half to one-mile radius, zip code, and city by comparing active pending and sold properties to the number of days it took for the properties to go pending and the total active and sold properties. This market exsorption rate determination process may then be repeated based on sold property buy price brackets, square footage, tax assessed on the property, property type, and additional property features or amenities, such as lot size, number of bedrooms, number of bathrooms, amount of parking available, or other features. One having skill in the art will recognize that many different property features on which to base an assessment. The Identified Property 410 may then be defined by its features, such as property type, property style, square footage, lot size, number of bedrooms, number of bathrooms, amount of parking available, etc. One having skill in the art will recognize that there may be many different property features on which to base an assessment. The Identified Property 410 features may then be compared to the data obtained from Server 130 for the Identified Property 410 neighborhood to find three active properties, three pending properties, and four sold properties with similar features. If properties meeting these criteria are not found, a search may be expanded from the neighborhood to properties within a two-mile radius, for example. This process may continue to the Identified Property 410 zip code, then the Identified Property 410 city until three active properties, three pending properties, and four sold properties with similar features are found. Identified Properties 410 that have specific features, such as view, waterfront, acreage, etc. are compared to two properties with similar features. Server 130 may provide a tax assessed value and a price per square foot for three active properties, three pending properties, and four sold properties, and sale price data for the sold properties. A tax-assessed percentage may be determined by comparing the tax-assessed value on the four sold properties to their respective sale price data. A modified tax assessed value may then be determined for the three active properties, three pending properties, and the Identified Property 410. The sale price data, price per square foot, and the modified tax assessed values are then used to report scores to Users 250 via their User Device 110, 140.

Possible Modifications may be Analyzed 430, with ROIs determined for various options. For example, one house may return $60,000 from a $50,000 kitchen renovation while another may only return $25,000 from the same renovation. Many factors may be considered to determine potential ROIs from modifications. Once Analyze Possible Modifications 430 has been performed, an overall ROI for the property may be Determined ROI 440. This determination may include contributions from ROIs for possible modifications, interest rates for mortgages, required work, and other considerations. Results Reported 450 by displaying or printing numbers, indicators such as a red/yellow/green evaluation, or any other way of allowing a user to determine if the property may be a good investment for the user. The ROI information may be displayed differently based upon preferences of the user. One having skill in the art will recognize that many different ways of displaying ROI information may be used.

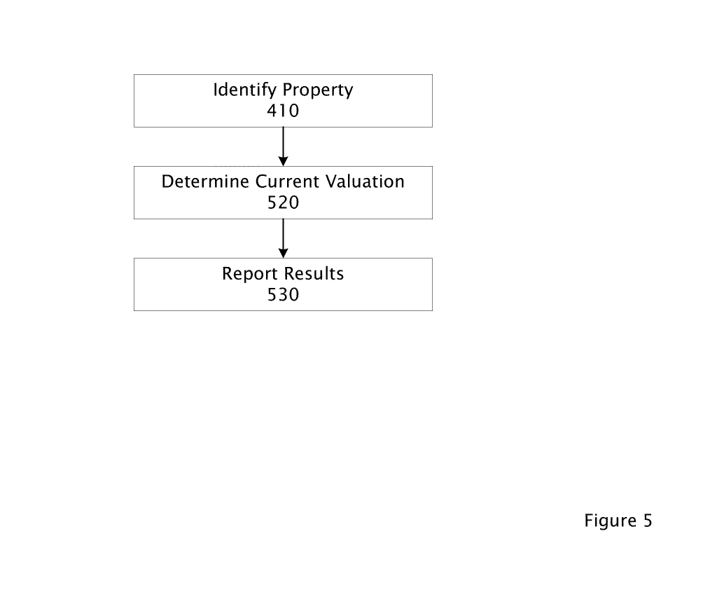

FIG. 5 is a flow diagram illustrating determining a rental value using Real Estate Information Management according to one embodiment. A Property may be Identified 410 as described above. Determine Current Valuation 520 may be performed by evaluating various factors pertaining to a potential rental property (target property). Other rental properties in a neighborhood of the target property may be compared. For example, comparable properties which are or have been rented may be identified and factors, attributes, compared. In one embodiment, comparable properties may be selected having a similar type, for example if the target property is a townhouse, comparable properties would include townhouses; but not condos or single family dwellings. Waterfront property may be compared to other properties with water frontage. Comparable properties may have construction dates within ten years of the target property. An acceptable number of bedrooms may be calculated, as shown in the following table:

TABLE 1

| | |
|---|---|
| Target Property | Comparable Property |

| Bedrooms | Sq. Ft. | Bedrooms | Sq. Ft. |
|---|---|---|---|
| Studio, 1 or 2 | | Same as target | |
| 3 | <1100 | 3 or 2 | +10% or −30% |
| | | | of target |
| 3 | >=1100 | 3 or 4 | +40% to −30% |
| | | | of target |
| 4 | | 3. 4, or 5 | |
| 5 | | 4, 5, 6 | |
| 6+ | | 5+ | |

Based on Table 1, for example, if a target property has three bedrooms and has more than 1100 sq. ft., a comparable property may have either three or four bedrooms, and may have up to forty percent higher, or up to thirty percent lower square footage.

If the target property has less than a one acre lot size, comparable properties may have up to one acre. If the target property has more than one acre, comparable properties may also have more than one acre.

Three comparable rental properties may be used to evaluate a base rental value. If three comparable properties are not found in the neighborhood, other properties within half a mile of the target property may be considered. If three comparable properties are not found in that area, properties within one mile may be considered. If comparable properties are still not found, an average rental cost for other rental properties in sharing a zip code of the target property may be used as a base rental value. A view or access to a golf course may add 10% to a rental value.

Results Reported 530 by displaying or printing numbers, indicators such as a red/yellow/green evaluation, or any other way of allowing a user to determine if the property may be a good rental for the user. The rental value information may be displayed differently based upon preferences of the user. One having skill in the art will recognize that many different ways of displaying rental value information may be used.

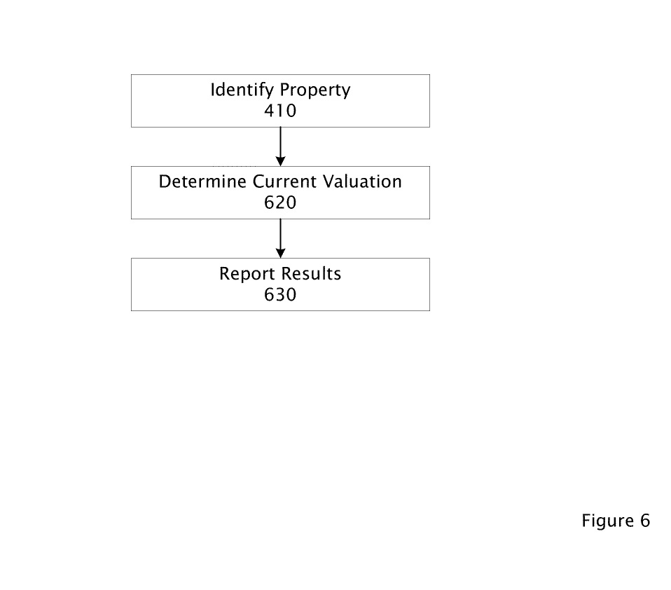

FIG. 6 is a flow diagram illustrating determining a purchase value using Real Estate Information Management according to one embodiment. A Property may be Identified 410 as described above.

Determine Current Valuation 520 may be performed by evaluating various factors pertaining to a potential purchase property (target property). Other properties in a neighborhood of the target property may be compared. For example, comparable properties may be identified and factors, attributes, compared. In one embodiment, comparable properties may be selected having a similar type, for example if the target property is a townhouse, comparable properties may include townhouses; but may not include condos or single family dwellings. A split-entry may be compared to other split-entry properties. Waterfront property may be compared to other properties with water frontage. Comparable properties may be in the same county as the target property. Comparable properties may have construction dates within ten years of the target property if the target property was built within the last ten years. If the target property is older than 14 years, comparable properties may be used up to ten years newer, but any age older than the target property. An acceptable number of bedrooms may be calculated, as shown in the following table:

TABLE 2

| | |
|---|---|
| Target Property | Comparable Property |

| Bedrooms | Sq. Ft. | Bedrooms | Sq. Ft. |
|---|---|---|---|
| Studio, 1 or 2 | | Same as target | |
| 3 | <1100 | 3 or 2 | +10% or −30% |
| | | | of target |
| 3 | >=1100 | 3 or 4 | +40% to −30% |
| | | | of target |
| 4 | | 3. 4, or 5 | |
| 5 | | 4, 5, 6 | |
| 6+ | | 5+ | |

Based on Table 2, for example, if a target property has three bedrooms and has more than 1100 sq. ft., a comparable property may have either three or four bedrooms, and may have up to forty percent higher, or up to thirty percent lower square footage than the target property.

If the target property has less than a one acre lot size, comparable properties may have up to one acre or up to ten percent more square feet than the target property. If the target property has more than one acre, comparable properties may also have more than one acre.

Three comparable properties may be used to evaluate a base purchase value. Comparable properties may have been sold within the last 60 days, may be pending, or, if enough comparable properties are not found within those criteria, sales going back longer periods of time may be considered. Comparable properties may be in a neighborhood with the target property. If three comparable properties are not found in the neighborhood, other properties sharing a school district with the target property may be considered. If three comparable properties are not found in that area, sharing a zip code of the target property may be used. If three comparable properties are still not found, other properties in the same city may be used, with closer properties being preferred for use as comparables. Other factors that may be considered in determining property values include, for example, land value, if there is a finished basement, water supply (well or municipal), heating source, condition of buildings, type and size of garage, other buildings on the property, easements, right-of-ways, school district, walkability ratings, bus lines, power lines, freeway or other road proximity, crime rate, and median or average income in the area. One having skill in the art will recognize that many factors may be included in evaluating a property.

If older sale values are used for comparable properties, adjustments may be made to determine a value in current market conditions. Factors may include the average number of days on market, sale prices in the area compared to tax assessed value, sales volumes, rate of houses being listed, land values in the neighborhood, number of active listings, number of pendings in previous 30 days, number of solds in previous 30 days, differences in list prices and sold prices, cost per square foot, average neighborhood appreciation, or other factors. One having skill in the art will recognize that many different approaches may be used to determine market value changes over time.

Results Reported 630 by displaying or printing numbers, indicators such as a red/yellow/green evaluation, or any other way of allowing a user to determine if the property may be a good purchase for the user. The value information may be displayed differently based upon preferences of the user. One having skill in the art will recognize that many different ways of displaying purchase value information may be used.

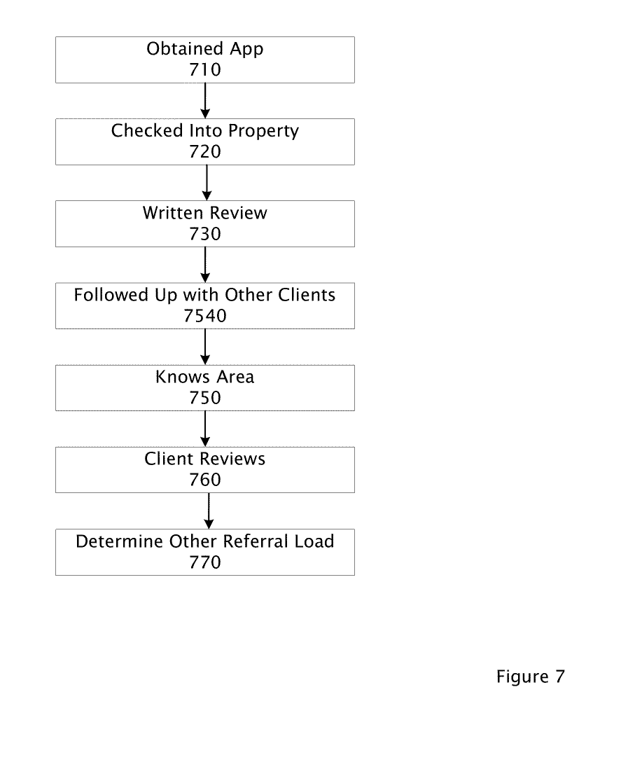

FIG. 7 is a flow diagram illustrating example techniques for rating an agent for a referral, according to one embodiment. If a client is interested in a property, the client may request to be put in touch with an agent. To select an agent for a referral, various factors may be considered. By assigning a point value to each factor, an overall rating may be determined, allowing a ranking and selection of an agent.

If an agent has Obtained App 710, the agent may be given a baseline assignment of 300 points. If the agent has Checked Into the Property 720 of interest to the client, 100 points may be assigned. A Written Review 730 of the property may provide 175 points. Real Estate Information Management may track a performance history of an agent and may add points based on past performance. If the agent has Followed Up with Other Clients 740 in a timely manner, for example, 200 points may be assigned. If the agent Knows the Area 750 in which the property of interest is located, as evidenced by previous sales, for example, an additional 100 points may be assigned. If an agent has good Client Reviews 760, 200 points may be assigned. Real Estate Information Management may also Determine Other Referral Load 770 for the agent, for example, if an agent has already received three referrals which the agent is working on, the agent may not have sufficient bandwidth to handle an additional potential client, and 300 points may be removed from the agent. Real Estate Information Management may determine a score for each agent registered with the system, or with a subset of agents with one or more particular properties, for example, only agents within a two mile radius of the subject property at the time of the request may be considered and evaluated. An agent receiving the highest overall score may be given the referral.

One having skill in the art will recognize that many different factors may be used to determine a ranking of agents for receiving a referral, and different weightings may be used for each factor.

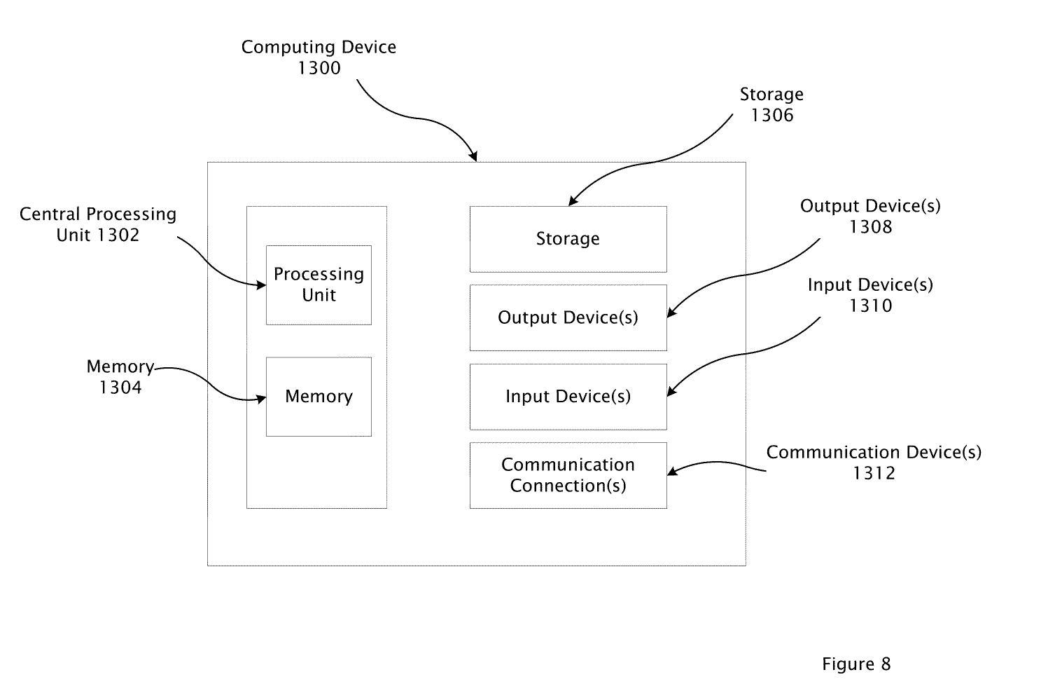

FIG. 8 illustrates a component diagram of a computing device according to one embodiment. The Computing Device (1300) can be utilized to implement one or more computing devices, computer processes, or software modules described herein, including, for example, but not limited to User Device 110, or a Server 130. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, or a Server 130. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302), also known as a processor, and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media include volatile and nonvolatile, removable and non-removable media implemented in any method or technology for storage of information such as computer-readable instructions, data structures, program modules or other data. Memory (1304) and Storage (1306) are all examples of computer storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer-readable storage media may be part of computing device (1300). Computer-readable storage media does not include transient signals.

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

1. A system, comprising:
a processor;
a memory, functionally coupled to the processor;
components disposed in the memory and operable on the processor, comprising:
a property identification component, configured to identify a first property and obtain a first list of attributes associated with the first property;
a value comparing component, configured to compare the first property with a second property having a second list of attributes and having a first value, assigning the first value adjusted based upon attributes of the first property and the second property, giving a second value, and assigning the second value to the first property; and
an output device, configured to output the second value.

2. A computer-implemented method, comprising:
receiving, from a user device, a request to provide a value for a first house;
receiving one or more features describing the first house;
finding, in a database, a second house having similar features;
determining, based upon a value of the second house, a value for the first house; and
outputting on a display on the user device, the determined value.

3. The method of claim 3, wherein the features are selected from a group consisting of: square footage, lot size, property type, property style, number of bedrooms, number of bathrooms, number of parking spaces, view, schools, school district, year built, new construction, area, neighborhood, county, city, zip code, amenities, and waterfront.

4. The method of claim 3, wherein the finding further comprises performing a search, the search initially filtered to a neighborhood.

5. The method of claim 3, further comprising calculating a value for a return on investment for the first house.

6. The method of claim 3, further comprises adjusting the determined value based upon market exsorption rates.

7. The method of claim 3, wherein the finding further comprises finding three active listings, three pending listings, and four sold listings.

8. A method for determining an agent to whom to give a referral, comprising:
calculating a point rating for each of a plurality of agents;
giving the referral to an agent having the highest point rating.

9. The method of claim 8, wherein the calculating a point rating for each agent further comprises:
adding a first number of points if the agent is using an application for tracking referrals;
adding a second number of points if the agent has checked into a property to which the referral applies;
adding a third number of points if the agent has written a review of the property;
adding a fourth number of points if the agent has previously followed up with clients in a timely manner;
adding a fifth number of points if the agent is familiar with an area in which the property is located; and
adding a sixth number of points if the agent has received favorable reviews on the application.
